(19) United States
(12) Patent Application Publication
(10) Pub. No.: US 2004/0005861 A1
(43) Pub. Date: Jan. 8, 2004

(54) Wireless communication terminal

(76) Inventor: Nobutaka Tauchi, Kariya-City (JP)

Correspondence Address: HARNESS, DICKEY & PIERCE, P.L.C., P.O. BOX 828, BLOOMFIELD HILLS, MI, 48303, US

(21) Appl. No.: 10/612,469

(22) Filed: Jul. 3, 2003

(30) Foreign Application Priority Data
Jul. 4, 2002 (JP) 2002-196149

(51) Int. Cl. H04B 3/36; H04B 7/14; H04B 7/15

(52) U.S. Cl. 455/11.1; 455/7

(57) ABSTRACT

A first wireless communication terminal has a normal communication function between the first terminal and a base station, and a relay communication function between a second wireless communication terminals and the base station. The first terminal spread-demodulates a relay signal, and spread-modulates the demodulated relay signal. The first terminal multiplexes the multiple relay signals to transmit the relay signal in the same time slots in response to an instruction from the base station. Therefore, the first terminal can relay many relay communications even in the case that a small number of free time slots remains for the relay communication.

### REFERENCE TO RELATED APPLICATIONS

This application is based on Japanese Patent Application No. 2002-196149 filed on Jul. 4, 2002, the contents of which are incorporated herein by reference.

### BACKGROUND OF THE INVENTION

1. Field of the Invention

The present invention relates to a wireless communication terminal, which performs communication with a base station (BS) and relay communication between other wireless communication terminal and the BS, and more particularly to using for a High Data Rate (HDR) multi-hop communication.

2. Description of Related Art

In recent years, a variety of enterprises and companies study and develop a multi-hop communication. The multi-hop communication is a communication technology that a first wireless communication terminal relays communication between a BS and a second wireless communication terminal. The BS provides a service area, the first terminal is located within the service area, and the second terminal is located outside the service area and does not communicate directly with the BS. The multi-hop communication enables the second terminal to communicate with the BS via the first terminal even if its current location is outside the service area.

For the multi-hop communication, the first terminal requires a relay communication function in addition to a normal communication function for communication with the BS. Such a wireless communication terminal is disclosed in Japanese Patent No. 3237323. The wireless communication terminal has both the normal communication function and the relay communication function. The relay communication function enables communication between the second terminal outside the service area and the BS, or between multiple second terminals. The terminal performs the normal communication in certain time slots and the relay communication in the other free time slots, using the Time Division Multiple Access/Time Division Duplex (TDMA/TDD) scheme.

However, in such a wireless communication terminal based on a time division scheme, the first terminal can merely perform one relay communication if the first terminal has only one free time slot. Namely, if a small number of free time slots remains in the first terminal, a small number of the relay communications is available.

### SUMMARY OF THE INVENTION

The present invention therefore has an object to provide a wireless communication terminal that performs an appropriate number of relay communications even if the terminal has a small number of free time slots. According to one aspect of the present invention, a first terminal includes a normal communication function and a relay communication function. The normal communication is a communication between the first terminal and a BS. The relay communication is communication between a second terminal and the BS.

The BS provides a service area, the first terminal is located within the service area, and the second terminal is located outside the service area and does not communicate directly with the BS. For the normal communication, the first terminal receives a normal downlink signal and transmits a normal uplink signal. For the relay communication, the first terminal receives a relay downlink signal from the BS and transmits it to the second terminal. The first terminal also receives a relay uplink signal from the second terminal and transmits it to the BS.

For the relay communication, a baseband processor of the first terminal spread-demodulates the received relay signal and spread-modulates the demodulated relay signal. Then, the baseband processor multiplexes the multiple re-modulated relay signals to transmit the relay signal in the same time slots in response to an instruction from the BS. As a result, the first terminal relays many communications between the second terminals and the BS even in the case that a small number of free time slots remains for the relay communication.

According to another aspect of the present invention, transmission rate setting means sets a transmission rate for the relay communication based on a condition of the service area. The first terminal relays many communications between the second terminals and the BS even in the case that a small number of free time slots remains for the relay communication because the first terminal sets the transmission rate based on the condition.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram of a wireless communication terminal according to a first embodiment of the present invention;

FIG. 2 is a schematical diagram showing the frequency bands used by the wireless communication terminal, which relays a communication between the other wireless communication terminal and a base station;

FIG. 3A is a timing chart showing the timing of a normal uplink transmission of the wireless communication terminal;

FIG. 3B is a timing chart showing the timing of a relay uplink reception of the wireless communication terminal;

FIG. 3C is a timing chart showing the state of a switch 138 of the wireless communication terminal;

FIG. 3D is a timing chart showing the state of a switch 142 of the wireless communication terminal;

FIG. 3E is a timing chart showing the timing of a normal downlink reception of the wireless communication terminal;

FIG. 3F is a timing chart showing the timing of a relay downlink transmission of the wireless communication terminal;

FIG. 3G is a timing chart showing the state of a switch 176 of the wireless communication terminal;

FIG. 3H is a timing chart showing the state of a switch 178 of the wireless communication terminal;

FIG. 4 is a flowchart showing the operation of the wireless communication terminal at the transmission of a relay-transmission signal;

FIG. 5 is a flowchart showing the operation of the wireless communication terminal at the transmission of a relay-reception signal; and

FIG. 6 is a block diagram of a wireless communication terminal according to a second embodiment.

### DETAILED DESCRIPTION OF PREFERRED EMBODIMENTS

The preferred embodiments of the present invention will be explained with reference to the accompanying drawings. In the drawing, the same numerals are used for the same components and devices.

[First Embodiment]

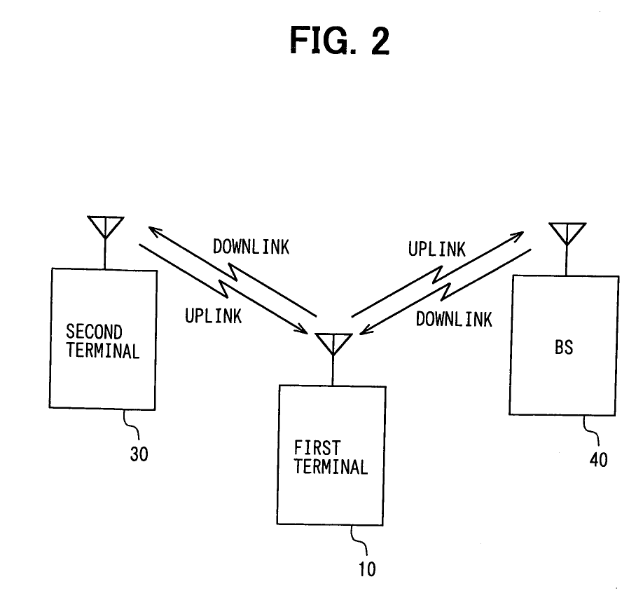

Referring to FIG. 2, a first wireless communication terminal 10 has a normal communication function and a relay communication function. The normal communication function is executed for communication between the first terminal 10 and a BS 40. The relay communication function is executed for communication between a second wireless communication terminal 30 and the BS 40 via the first terminal 10. The BS provides a service area. The first terminal 10 is located within the service area and the second terminal is located outside the service area and does not communicate directly with the BS 40.

The first terminal 10 uses a packet data communication scheme such as HDR, which is derived from the Code Division Multiple Access (CDMA)-based cellular telephone system. The packet data communication scheme is one type of time division communication schemes. The first terminal 10 and the second terminal 30 are mobile terminals that can be placed on vehicles or carried by persons. In the CDMA system, signals of individual communication channels are multiplied by different spread codes. The individual multiplied signal is multiplexed, and the multiplexed signal is transmitted and received.

An uplink frequency band is different from a downlink frequency band. For the normal communication, the first terminal 10 receives a normal downlink signal from the BS 40 in the downlink frequency band and transmits a normal uplink signal to the BS 40 in the uplink frequency band. For the relay communication, the first terminal 10 receives a relay downlink signal from the BS 40 and transmits it to the second terminal 30 in the downlink frequency band. The first terminal 10 also receives a relay uplink signal from the second terminal 30 and transmits it to the BS 40 in the uplink frequency band. That is, the first terminal 10 uses the uplink/downlink frequency bands for the relay communication in the opposite manner as the normal communication. Furthermore, the first terminal 10 transmits and receives the relay signals in two frequency bands, respectively, in addition to the normal communication.

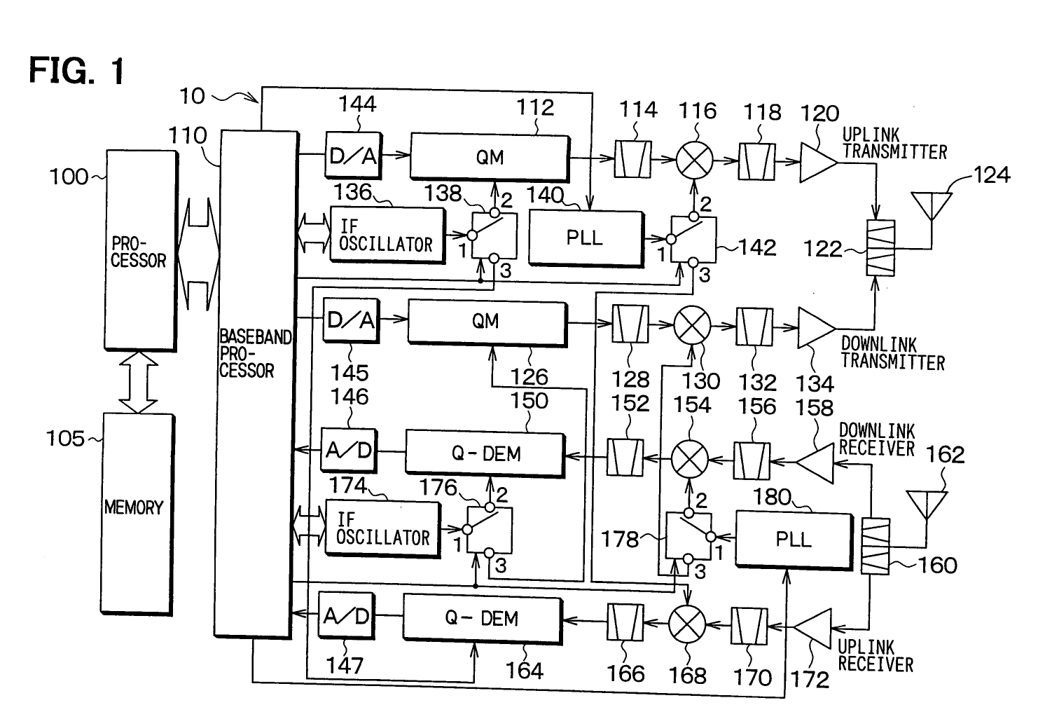

Referring to FIG. 1, the first terminal 10 has two transmitters and two receivers each tuned to the uplink and downlink frequency bands. The transmitters include an uplink transmitter and a downlink transmitter. The receivers include an uplink receiver and a downlink receiver.

The uplink transmitter includes a D/A converter 144, a transmission quadrature modulator (QM) 112, a transmission IF band-pass filter (IF-BPF) 114, a transmission band up-converter 116, a transmission RF band-pass filter (RF-BPF) 118, and a transmission RF amplifier (RF-AMP) 120. The uplink transmitter transmits the normal uplink signal and the relay uplink signal to the BS 40. The downlink transmitter includes a D/A converter 145, a reception QM 126, a reception IF-BPF 128, a reception band up-converter 130, a reception RF-BPF 132, and a reception RF-AMP 134. The downlink transmitter transmits the relay downlink signal to the second terminal 30. The uplink transmitter and the downlink transmitter share a transmission duplexer 122 and a transmission antenna 124.

The D/A converter 144 receives output I-Q data from a baseband processor 110 and converts it to an analogue I-Q signal with D/A conversion. Then, it sends the I-Q signal to the transmission QM 112. The transmission QM 112 receives the I-Q signal and a frequency signal (sine wave) from a transmission IF local oscillator 136 via a uplink IF switch 138. The transmission QM 112 quadrature-modulates the I-Q signal using the frequency signal and produces an uplink intermediate frequency (IF) signal. The transmission IF-BPF 114 eliminates redundant frequency components from the uplink IF signal.

The transmission band up-converter 116 receives the uplink IF signal and a high frequency signal from a transmission high-frequency (high-freq) PLL circuit 140 via a uplink radio frequency (RF) switch 142. The up-converter 116 multiplies the uplink IF signal by the high frequency signal and produces a transmittable uplink RF signal. The transmission RF-BPF 118 eliminates redundant frequency components from the transmittable uplink RF signal. The transmission RF-AMP 120 amplifies the transmittable uplink RF signal as the normal uplink signal or the relay uplink signal. The transmittable uplink RF signal is transmitted from the transmission antenna 124 to the BS 40 via the transmission duplexer 122.

The downlink transmitter transmits the relay downlink signal in the same manner as the uplink transmitter. The D/A converter 145 receives output I-Q data from the baseband processor 110 and converts it to an analog I-Q signal with D/A conversion. The reception QM 126 receives the I-Q signal and a frequency signal from a reception IF local oscillator 174 via a downlink IF switch 176. The reception QM 126 quadrature-modulates the I-Q signal with the frequency signal to produce a downlink IF signal. The reception IF-BPF 128 eliminates redundant frequency components from the downlink IF signal.

The reception band up-converter 130 receives the downlink IF signal and a high frequency signal from a reception high-freq PLL circuit 180 via a downlink RF switch 178. The up-converter 130 multiplies the downlink IF signal by the high frequency signal and produces a transmittable downlink RF signal. The reception RF-BPF 132 eliminates redundant frequency components from the transmittable downlink RF signal. The reception RF-AMP 134 amplifies the transmittable downlink RF signal as the relay downlink signal. The transmittable downlink RF signal is transmitted from the transmission antenna 124 to the second terminal 30 via the transmission duplexer 122.

The downlink receiver includes a reception band low-noise amplifier (LNA) 158, a reception RF-BPF 156, a reception band down-converter 154, a reception IF-BPF 152, a reception quadrature-demodulator (Q-DEM) 150, and an A/D converter 146. The downlink receiver receives the normal downlink signal and the relay downlink signal from the BS 40. The uplink receiver includes a transmission band LNA 172, a transmission RF-BPF 170, a transmission down-converter 168, a transmission IF-BPF 166, a transmission Q-DEM 164, and an A/D converter 147. The uplink receiver receives the relay uplink signal from the second terminal 30. The downlink receiver and the uplink receiver share a reception duplexer 160 and a reception antenna 162.

The reception band LNA 158 receives a downlink RF signal from the BS 40 via the reception antenna 162 and the reception duplexer 160, and amplifies the downlink RF signal. The reception RF-BPF 156 eliminates redundant frequency components from the downlink RF signal. The reception band down-converter 154 receives the downlink RF signal and a high frequency signal from the reception high-freq PLL circuit 180 via the downlink RF switch 178. The down-converter 154 multiplies the downlink RF signal by the high frequency signal and produces a downlink IF signal.

The reception IF-BPF 152 eliminates redundant frequency components from the downlink IF signal. The reception Q-DEM 150 receives the downlink IF signal and a frequency signal from the reception IF local oscillator 174 via the downlink IF switch 176. The reception Q-DEM 150 quadrature-demodulates the downlink IF signal with the frequency signal and produces a downlink I-Q signal. The A/D converter 146 converts the downlink I-Q signal to downlink I-Q data with A/D conversion and sends it to the baseband processor 110. The baseband processor 110 receives the downlink I-Q data as a downlink input I-Q data.

The uplink receiver receives the relay uplink signal in the same manner as the downlink receiver. The transmission band LNA 172 receives an uplink RF signal from the second terminal 30 via the reception antenna 162 and the reception duplexer 160, and amplifies the uplink RF signal. The transmission RF-BPF 170 eliminates redundant frequency components from the uplink RF signal. The transmission band down-converter 168 receives the uplink RF signal and a high frequency signal from the transmission high-freq PLL circuit 140 via the uplink RF switch 142. The down-converter 168 multiplies the uplink RF signal by the high frequency signal and produces an uplink IF signal.

The transmission IF-BPF 166 eliminates redundant frequency components from the uplink IF signal. The transmission Q-DEM 164 receives the uplink IF signal and a frequency signal from the transmission IF local oscillator 136 via the uplink IF switch 138. The transmission Q-DEM 164 quadrature-demodulates the uplink IF signal with the frequency signal and produces an uplink I-Q signal. The A/D converter 147 converts the uplink I-Q signal to uplink I-Q data with A/D conversion and sends it to the baseband processor 110. The baseband processor 110 receives the uplink I-Q data as a downlink input I-Q data.

The first terminal 10 includes the transmission. IF local oscillator 136 and the transmission high-freq PLL circuit 140, which is used by the uplink transmitter and the uplink receiver. The first terminal 10 also includes the reception IF local oscillator 174 and reception high-freq PLL circuit 180, which is used by the downlink transmitter and the downlink receiver. Oscillation frequencies of the transmission high-freq PLL circuit 140 and reception high-freq PLL circuit 180 are variable. The first terminal 10 further includes the uplink IF switch 138, the uplink RF switch 142, the downlink IF switch 176, and the downlink RF switch 178. The IF switches 138, 176 switch outputs of the IF local oscillators 136, 174 in accordance with control signals from the baseband processor 110. The RF switches 142, 178 switch outputs of the PLL circuits 140, 180 in accordance with the control signals.

The first terminal 10 further includes a digital processor for processing the input I-Q data received from the uplink and the downlink receivers, and preparing the output IQ data for the uplink and the downlink transmitters. The digital processor includes a computational processor 100, a memory 105, and the baseband processor 110.

The baseband processor 110 receives the input I-Q data from the reception Q-DEM 150 or the transmission Q-DEM 164 via the A/D converter 146 or 147, respectively. When the baseband processor 110 receives the input I-Q data, it demodulates the input I-Q data based on a narrow-band demodulation scheme such as BPSK, QPSK, 16QAM and 64QAM. The baseband processor 110 despreads the demodulated data with a specific spread code, produces the despreaded data, and sends it to the computational processor 100. The narrow-band demodulation is one type of demodulation.

When the baseband processor 110 receives transmission data from the computational processor 100, it spreads the transmission data with a specific spread code. Then, it modulates the spreaded data into quadrature-coded I-Q data based on a specific narrow-band modulation scheme such as BPSK, QPSK, 16QAM and 64QAM. Then, the baseband processor produces the quadrature-coded output I-Q data and sends it to the transmission QM 112 or the reception QM 126 via the D/A converter 144 or 145, respectively. The narrow-band modulation is one type of modulation.

The baseband processor 110 receives commands from the computational processor 100 and operates in accordance with the commands. The baseband processor 110 controls the reception IF-BPF 152, the reception RF switch 178, the transmission high-freq PLL circuit 140, and the reception high-freq PLL circuit 180 in accordance with the commands. The baseband processor 110 determines to which the D/A converter 144 or 145 to send the output I-Q data in response to the command.

The computational processor 100 includes a CPU, which loads a program from the memory 105 and operates in accordance with the loaded program. Specifically, the CPU processes data from the baseband processor 110 for transmission, and sends the data and commands to the baseband processor 110.

The computational processor 100 saves different kinds of data to and loads the data from the memory 105 whenever it is necessary. For example, the computational processor 100 loads an application program such as a Web browser and a mailer from the memory 105, processes the data from the memory 105 in accordance with the application program, and sends the data to a display (not shown). The computational processor 100 receives data inputted from an input device (not shown) by the user of the first terminal 10, produces data for the application program in accordance with the input data, and sends the data to the baseband processor 110.

When the first terminal 10 transmits the normal uplink signal in the normal communication, the baseband processor 110 responds to the switching command of the processor 100. The baseband processor 110 controls the transmission IF switch 138 so that the transmission IF local oscillator 136 connects to the transmission QM 112 (1-2 connection of the switch 138). The baseband processor 110 also controls the transmission RF switch 142 so that the transmission high-freq PLL circuit 140 connects to the transmission band up-converter 116 (1-2 connection of the switch 142). Then, the processor 100 sends the transmission data and a command to the baseband processor 110 for sending the transmission data from the baseband processor 110 to the D/A converter 144. Consequently, the uplink transmitter transmits the transmission data received from the processor 100 to the outside.

At this time, neither the oscillator 136 nor the PLL circuit 140 sends the frequency signal to the transmission QDEM 164 and the down-converter 168, respectively. Therefore, the uplink receiver does not receive the uplink signal transmitted from the uplink transmitter, and a loop of communication does not occur in the first terminal 10.

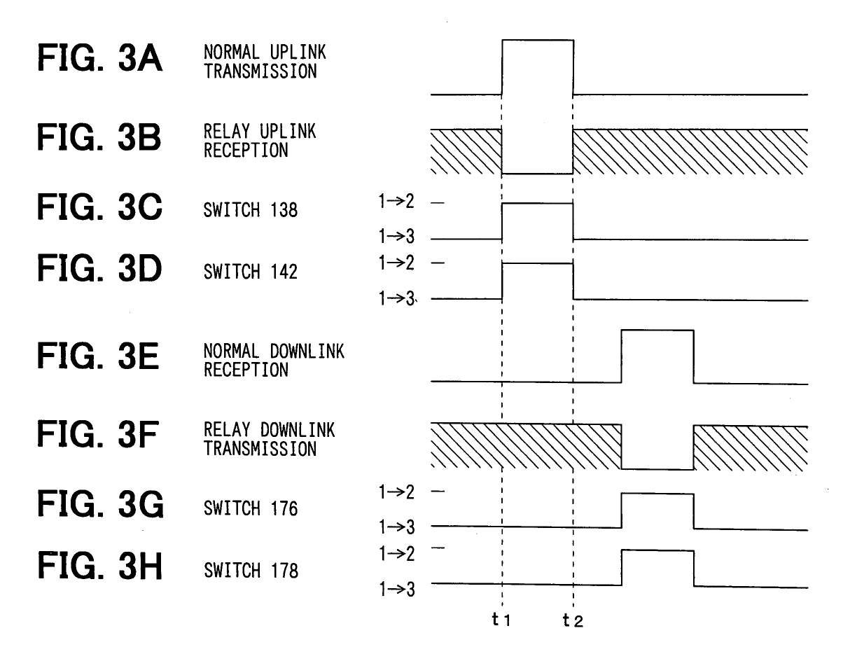

FIGS. 3A to 3H show the timing of the transmission operation, the reception operation, and the states of the switches 138, 142, 176, 178 along with the time axis extending to the right. The normal uplink transmission takes place in a first time slot from t1 to t2. In the first time slot, the IF switch 138 and the RF switch 142 have the states of 1-2 conduction as shown in FIGS. 3C, 3D. Reception by the uplink receiver, which is reception of the relay uplink signal, is took place in the other time slots excluding the first time slot as shown in FIG. 3B.

When the first terminal 10 receives the normal downlink signal in the normal communication, the baseband processor 110 controls the IF switch 176 so that the IF oscillator 174 connects to the reception Q-DEM 150 (1-2 connection of the switch 176) based on the switching command of the processor 100. The baseband processor 110 also controls the RF switch 178 so that the PLL circuit 180 connects to the down-converter 154 (1-2 conduction of the switch 178). Consequently, the downlink receiver receives the normal downlink signal.

At this time, neither the IF oscillator 174 nor the PLL circuit 180 sends the frequency signal to the reception QDEM 126 and the up-converter 130, respectively. As a result, the downlink transmitter does not transmit the downlink signal. Accordingly, the downlink receiver does not receive the downlink signal from the downlink transmitter as shown in FIGS. 3E to 3H, and a loop of communication does not occur in the first terminal 10.

When the first terminal 10 receives the relay uplink signal from the second terminal 30 in the relay communication, the baseband processor 110 controls the IF switch 138 so that the IF oscillator 136 connects to the transmission Q-DEM 164 (1-3 connection of the switch 138) based on the switching command. The baseband processor 110 also controls the RF switch 142 so that the PLL circuit 140 connects to the down-converter 168 (1-3 connection of the switch 142). Consequently, the uplink receiver receives the relay uplink signal.

At this time, neither the IF oscillator 136 nor the PLL circuit 140 sends the frequency signal to the transmission QM 112 and the up-converter 116, respectively. As a result, the uplink transmitter does not transmit the uplink signal. Accordingly, the uplink receiver does not receive the uplink signal from the uplink transmitter, and a loop of communication does not occur in the first terminal 10.

When the first terminal 10 transmits the relay uplink signal to the BS 40 in the relay communication, the switches 138, 142, 176, 178 are controlled in the condition same as the normal uplink communication, and the uplink transmitter transmits the relay uplink signal.

When the first terminal 10 receives the relay downlink signal from the BS 40 in the relay communication, the switches 138, 142, 176, 178 are controlled in the condition same as the normal downlink communication, and the downlink receiver receives the relay downlink signal.

When the first terminal 10 transmits the relay downlink signal to the second terminal 30, the baseband processor 110 controls the IF switch 176 so that the oscillator 174 connects to the reception QM 126 (1-3 connection of the switch 176) based on the switching command. The baseband processor 110 also controls the RF switch 178 so that the PLL circuit 180 connects to the up-converter 130 (1-3 connection of the switch 178). The processor 100 sends the relay downlink data and a command to the baseband processor 110 for sending the data to the D/A converter 145. Consequently, the downlink transmitter transmits the relay downlink signal to the second terminal 30.

At this time, neither the oscillator 174 nor the PLL circuit 180 sends the frequency signal to the reception Q-DEM 150 and the down-converter 154, respectively. Therefore, the downlink receiver does not receive the relay downlink signal transmitted from the downlink transmitter, and a loop of communication does not occur in the first terminal 10.

Accordingly, the first terminal 10 can perform not only the normal communication, but also the relay communication as explained above. The relay downlink signal and the relay uplink signal received by the first terminal 10 are demodulated with the narrow-band demodulation, modulated with the narrow-band modulation, and transmitted to the second terminal 30 or the BS 40. Since the first terminal 10 demodulates and modulates the signal, it can alter the narrow-band modulation scheme, the spread code, and the transmission rate and frequency when is modulates the signal. The first terminal 10 transmits the normal uplink signal and the relay uplink signal from the same uplink transmitter. The first terminal 10 can transmit both uplink signals simultaneously in one time slot based on the multiplexing (multi-code multiplexing) with separate spread codes.

The timing of transmission and reception, the spread codes, and the type of narrow-band modulation scheme are determined by the instructions from the BS 40. The instructions include the timings of the normal communication, the relay communication, the spread codes, the type of narrow-band modulation scheme, and the transmission rate and frequency of the first terminal 10. The BS 40 or a server, which is linked to the BS 40, determines the instructions based on the condition. The condition includes the state of the service area, the quantity of free time slots (number, proportion, etc.), the location of the first terminal 10, and the communication qualities of the frequency bands. The instructions are informed to the first terminal 10 using a control communication time slot in advance. The first terminal 10 receives and stores the instructions in the memory 105 as property information. The first terminal 10 performs the normal communication and the relay communication in accordance with the property information. As a result, the BS 40, the first terminal 10 and the second terminal 30 can operate in unison to execute the relay communication.

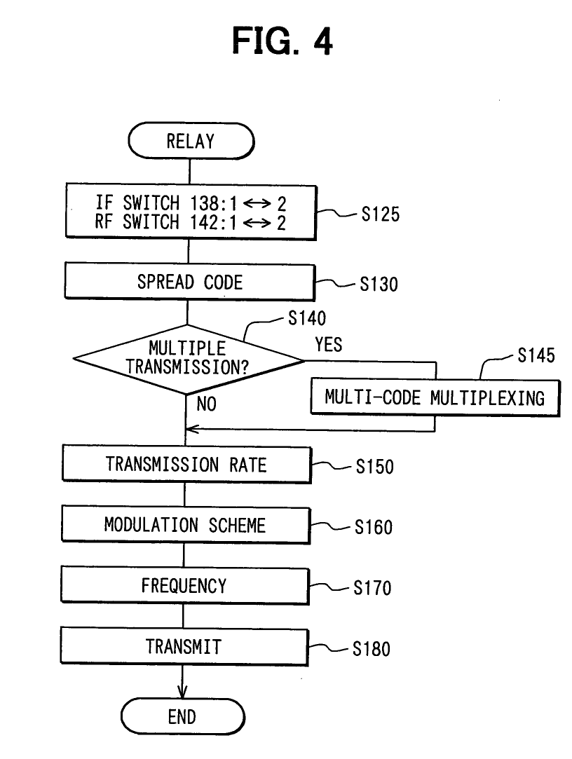

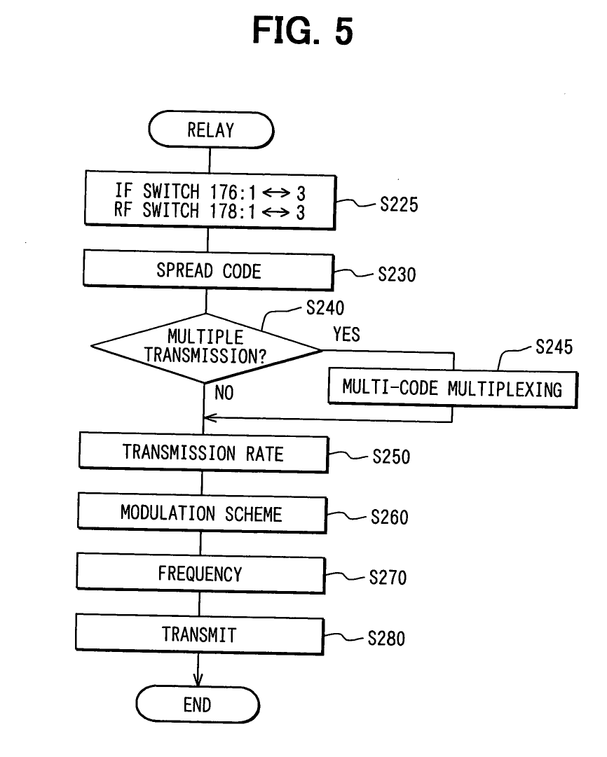

FIG. 4 and FIG. 5 show flowcharts of the transmission operation implemented by the computational processor 100 at a predetermined transmission timing of the relay downlink signal and the relay uplink signal. Before starting the transmission operation, the first terminal 10 has already received the relay signals and stored the corresponding data in the memory 105.

At the timing that the normal uplink signal and the relay uplink signal are transmitted to the BS 40, the processor 100 sends the switching command to the baseband processor 110. The switching command causes that the IF switch 138 and RF switch 142 have both the 1-2 connection state so that the uplink transmitter is usable (S125).

In step S130, the processor 100 fetches the spread code specified for the transmission of the relay uplink data depending on the property information. Then the processor 100 sends the command to the baseband processor 110 to modulate the data with the specified spread code by spread-modulation. The spread code, the following transmission rate and frequency, and narrow-band modulation scheme can be different from those used at the reception of the relay uplink signal from the second terminal 30.

In step S140, the processor 100 judges as to whether multiple kinds of signals exist for the transmission. Upon detecting the multiple signals, the processor 100 produces the command so that the baseband processor 110 spread-modulates the signals with the each spread code specified by the BS 40 (S145). The step S145 is skipped if only one uplink signal exists for the transmission.

In step S150, the processor 100 fetches the specified transmission rate from the property information. The processor 100 produces the command so that the baseband processor 110 transmits the signal(s) at the specified transmission rate (spreading factor).

In step S160, the processor 100 fetches the specified narrow-band modulation scheme such as BPSK, QPSK, 16QAM and 64QAM from the property information. The processor 100 produces the command so that the baseband processor 110 quadrature-modulates the transmission data with the specified narrow-band modulation scheme. The setting of the narrow-band modulation scheme is one type of the setting of the transmission rate.

In step S170, the processor 100 fetches the specified transmission frequency within the uplink band from the property information. The processor 100 produces the command to the baseband processor 110 to control the PLL circuit 140 so that it is tuned to the specified transmission frequency.

In step S180, the processor 100 sends the relay uplink data or the normal uplink data or both to the baseband processor 110. The uplink transmitter transmits the corresponding signal(s) to the BS 40 in accordance with the conditions set in the steps S130 to S170.

Referring to FIG. 5, at the timing that the relay downlink signal is transmitted to the second terminal 30, the processor 100 produces the switching command to the baseband processor 110. The switching command causes that the IF switch 176 and RF switch 178 have both the 1-3 connection state so that the downlink transmitter is usable (step S225). The subsequent operations of step S230 through step S270 for setting the spread code, the multi-code multiplexing, the transmission rate, the narrow-band modulation scheme, and the transmission frequency are identical to the operations of step S130 through step S170 shown in FIG. 4.

In step S280, the processor 100 sends the relay downlink data to the baseband processor 110. Then, the downlink transmitter transmits the relay downlink signal to the second terminal 30 in accordance with the conditions set in the steps S240 to S270.

Based on the foregoing relay communication operation of the first terminal 10, the first terminal 10 implements the multi-code multiplexing in compliance with the property information so that the multiple signals are transmitted in one time slot. As a result, the first terminal 10 performs many relay communications even in the case that a small number of free time slots remains in the first terminal 10. In addition, altering the transmission rate or the narrow-band modulation scheme can raise the transmission speed.

In steps S170 and S270, the frequency setting is not obliged within the uplink band. The frequency may be altered across a wider frequency band so that the normal communication and the relay communication can take place consecutively while switching the communications.

[Second Embodiment]

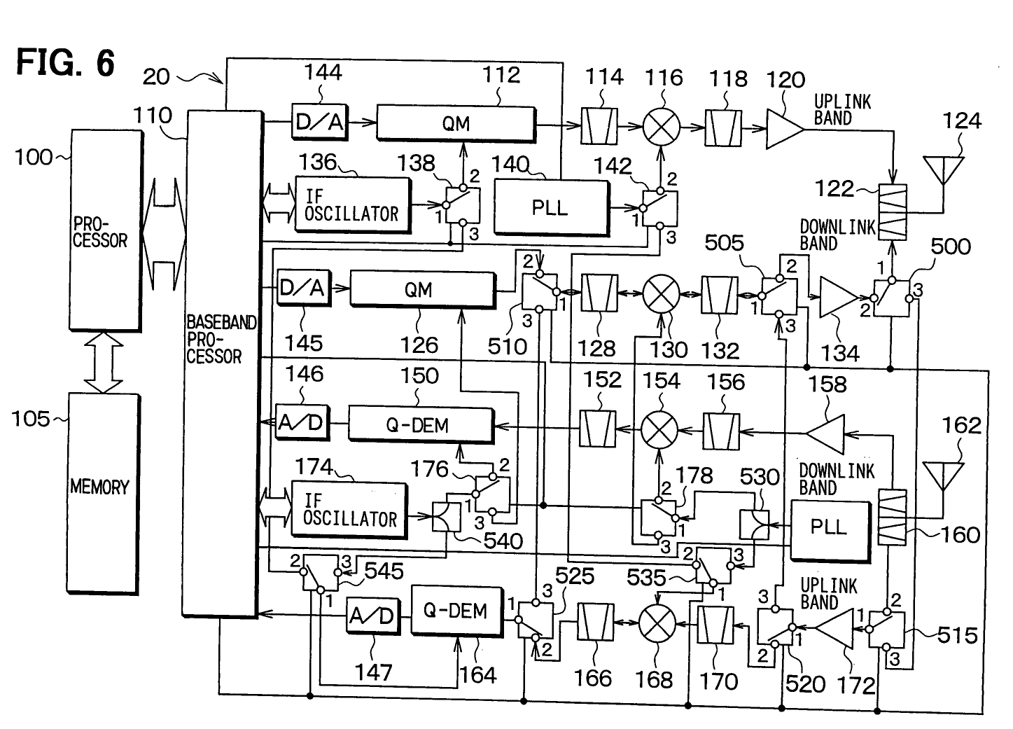

FIG. 6 shows the arrangement of a wireless communication terminal 20 based on the second embodiment. The terminal 20 further includes a reception switches 500, 505, 515 and 520, IF switches 510 and 525, distributors 530 and 540, and switches 535 and 545, in addition to the constituents of the first terminal 10 of the first embodiment.

The reception switch 500 selects an input source of the transmission duplexer 122 (switch terminal 1) from among the reception RF-AMP 134 (terminal 2) and reception switch 515 (terminal 3). The reception switch 505 selects an output connection of the reception RF-BPF 132 (switch terminal 1) from among the reception RF-AMP 134 (terminal 2) and reception switch 520 (terminal 3). The reception switch 510 selects an output connection of the reception IF-BPF 128 (switch terminal 1) from among the reception QM 126 (terminal 2) and IF switch 525 (terminal 3). The reception switch 515 selects an input source of the transmission band LNA 172 (switch terminal 1) from among the reception duplexer 160 (terminal 2) and reception switch 500 (terminal 3).

The reception switch 520 selects an output connection of the transmission band LNA 172 (switch terminal 1) from among the transmission RF-BPF 170 (terminal 2) and reception switch 505 (terminal 3). The reception switch 525 selects an output connection of the transmission Q-DEM 164 (switch terminal 1) from among the transmission IF-BPF 166 (terminal 2) and IF switch 510 (terminal 3). The switch 535 selects an input source of the transmission band down-converter 168 (switch terminal 1) from among the transmission RF switch 142 (terminal 2) and distributor 530 (terminal 3). The switch 545 selects an input source of the transmission Q-DEM 164 (switch terminal 1) from among the transmission IF switch 138 (terminal 2) and distributor 540 (terminal 3). The switches are controlled by the baseband processor 110 receiving the switching commands from the computational processor 100.

The distributor 530 distributes the output of the reception high-freq PLL circuit 180 to the RF switch 178 and the switch 535. The distributor 540 distributes the output of the oscillator 174 to the IF switch 176 and the switch 545.

The terminal 20 has exactly the same transmission and reception operation as the first terminal 10 when the reception switches 500, 505, 515 and 520, IF switches 510 and 525, and switch 535 have all the 1-2 connection state.

When all of the switches have the 1-3 connection state, the transmission antenna 124 receives the normal downlink signal from the BS 40 and sends it to the transmission duplexer 122. The transmission band LNA 172 amplifies the signal. The reception RF-BPF 132 removes redundant frequency components of the signal. The up-converter 130 multiplies the signal by the frequency signal from the PLL circuit 180 so that the signal is down-converted into the downlink IF signal. Then, the IF-BPF 128 removes redundant frequency components of the signal. The transmission Q-DEM 164 quadrature-demodulates the signal with the frequency signal from the oscillator 174. The A/D converter 147 converts the signal with A-D conversion and sends it to the baseband processor 110. The downlink receiver can operate for the normal reception. However, the terminal 20 cannot relay the relay signal since the downlink transmitter, the downlink receiver and the uplink receiver are used for reception.

Accordingly, when the terminal 20 does not perform the relay communication, the reception path serves as diversity branch for the normal communication. The reception path includes the transmission duplexer 122, the transmission band LNA 172, the reception band up-converter 130, the transmission Q-DEM 164, and so on. As a result, dual system for the normal reception enhances the performance and reliability of the terminal 20.

The multi-code multiplexing operations by the computational processor 100 described for the steps S140 and S145 in FIG. 4 and the steps S240 and S245 in FIG. 5 correspond to the multiplex controller. The operations of the computational processor 100 described for the steps S150 and S160 in FIG. 4 and the steps S250 and S260 in FIG. 5 correspond to the transmission rate setting means.

The present invention should not be limited to the embodiments previously discussed and shown in the figures, but may be implemented in various ways without departing from the spirit of the invention. For example, in the foregoing embodiments, the terminals 10 and 20 implement the spread code setting, the transmission rate setting, the modulation scheme setting, the frequency setting, and the multi-code multiplexing in response to the instruction from the BS 40. However, the terminal may be designed to implement the setting autonomously based on the condition within their communication area. The condition of communication may be informed by the BS, or may be monitored by the terminal itself.

What is claimed is:

1. A wireless communication terminal operating based on a time division scheme and having a normal communication function between the terminal and a base station and a relay communication function between a second wireless communication terminal and the base station, the terminal comprising:
a baseband processor that spread-demodulates relay signals and spread-modulates the spread-demodulated relay signals; and
a multiplex controller performing an operation for producing a command so that the baseband processor multiplexes the spread-modulated relay signal with the other spread-modulated relay signal.

2. The wireless communication terminal according to claim 1, wherein the multiplex controller changes the operation based on a condition within a service area of the terminal.

3. The wireless communication terminal according to claim 1, wherein the multiplex controller changes the operation in response to an instruction from the base station.

4. A wireless communication terminal operating based on a time division scheme and having a normal communication function between the terminal and a base station and a relay communication function between a second wireless communication terminal and the base station, the terminal comprising:
a baseband processor that demodulates a relay signal and modulates the demodulated relay signal; and
transmission rate setting means for setting a transmission rate for the relay communication based on a condition within a service area of the base station.

5. The wireless communication terminal according to claim 4, wherein the transmission rate setting means changes the transmission rate in response to an instruction from the base station.

6. The wireless communication terminal according to claim 4, wherein the transmission rate setting means changes a modulation scheme of the baseband processor to set the transmission rate.

7. The wireless communication terminal according to claim 2, wherein the condition is the number of free time slots of the time division scheme of the wireless communication terminal.

8. The wireless communication terminal according to claim 4, wherein the condition is the number of free time slots of the time division scheme of the wireless communication terminal.
